(19) United States
(12) Patent Application Publication
(10) Pub. No.: US 2021/0264795 A1
(43) Pub. Date: Aug. 26, 2021

(54) FAULT-TOLERANT CONTROL SYSTEM AND METHOD

(71) Applicant: PROWLER .IO LIMITED, Cambridgeshire (GB)

(72) Inventor: David MGUNI, Cambridgeshire (GB)

(73) Assignee: PROWLER .IO LIMITED, Cambridgeshire (GB)

(21) Appl. No.: 16/796,057

(22) Filed: Feb. 20, 2020

(51) Int. Cl. G08G 5/00; G07C 5/08; G07C 5/00; G06N 3/08

(52) U.S. Cl. CPC G08G 5/003; G07C 5/0816; B64C 39/024; G08G 5/0013; G06N 3/08; G07C 5/008

(57) ABSTRACT

A computer implemented method includes receiving data indicative of one or more experience tuples each comprising a first observation including a first location of an unmanned aerial vehicle, UAV, a first flight action performed by the UAV in dependence on the first observation, a reward associated with the performance of the first flight action, and a second observation including a second location of the UAV following the performance of the first action. For each of the one or more experience tuples, the method includes, at a computing system: processing the first observation, using a value estimator with current parameter values, to determine a first estimated return for the first flight action following the first observation; processing the second observation, using a target value estimator with an identical architecture to the value estimator, to determine a set of candidate estimated returns, each of the set of candidate estimated returns corresponding to a respective one of a set of candidate second flight actions following the second observation; determining a greatest of the determined candidate estimated returns; determining a terminal reward associated with a triggering of a failure condition corresponding to a failure of a physical component of the UAV following the UAV visiting the second location of the UAV; determining, using the determined terminal reward and the greatest candidate estimated return, a second estimated return for the first flight action following the first observation, accounting for an intervention by an adversarial stopping agent arranged to trigger the failure condition when predetermined stopping criteria are satisfied; and updating the current parameter values of the value estimator in dependence upon a difference between the first estimated return and the second estimated return. After being sequentially updated in accordance with each of the one or more experience tuples, the current parameter values of the value estimator are trained parameter values.

### BACKGROUND OF THE INVENTION

### Field of the Invention

The present invention relates the programming of control systems using reinforcement learning. The invention has particular, but not exclusive, relevance to the programming of control systems using Q-learning or deep Q-learning.

Description of the Related Technology

Reinforcement learning describes a class of machine learning methods in which a computer-implemented learner aims to determine how a task should be performed by observing a control agent interacting with an environment. In a canonical reinforcement learning setting, the control agent makes a first observation characterizing a first state of the environment, selects and performs an action in dependence on the first observation, and following the performance of the action, makes a second observation characterizing a second state of the environment and receives a reward. The control agent thereby generates data indicative of an experience tuple containing the first observation, the performed action, the second observation and the reward. Over time, the control agent generates experience data indicative of many of these experience tuples, and this experience data is processed by a computer-implemented learner for processing. The goal of the learner is to determine a policy which maximizes a value for each possible state observation, where the value is defined as the expected discounted future reward (also referred to as the expected return) for that state observation, as shown by Equation (1):

$$V ( s ) = 𝔼 [ {\sum }_{t = 0}^{T} {γ}^{t} R ( {s}_{t} , {a}_{t} ) \vert {s}_{0} = s ] , \qquad ( 1 )$$

in which: V(s) is the value of the state observation; τ=(s₀, a₀, s_{T}, a_{T}) is a trajectory of state observations and actions induced by the control agent following the policy; R(sₜ, aₜ) is a reward received by the control agent following the performance of an action aₜ in response to a state observation sₜ; T is the length of an episode for which the control agent interacts with the environment, which may be finite (in which case the task is referred to as episodic) or infinite (in which case the task is referred to as ongoing); and γ ∈ (0,1] is a discount factor which ensures convergence of the sum in Equation (1) for ongoing tasks and affects how much a control agent should take into account likely future states when making decisions

Q-learning is a reinforcement learning method in which, instead of learning a policy directly, a learner trains a value estimator which estimates the expected return for each action available to the control agent in response to a given state observation, as defined by Equation (2):

$$Q ( s , a ) = 𝔼 [ {\sum }_{t = 0}^{T} {γ}^{t} R ( {s}_{t} , {a}_{t} ) \vert {s}_{0} = s , {a}_{0} = a ] . \qquad ( 2 )$$

The value estimator may be implemented in various ways, for example using a lookup table or a basis function expansion. In deep Q-learning, the value estimator is implemented using a deep neural network. Once the value estimator has been trained, an optimal policy for the control agent is to select the action with the highest output of the value estimator in response to any given state observation. In order to train the value estimator, the learner processes individual experience tuples to iteratively update parameter values of the value estimator. Since the individual experience tuples are generated by a control agent following a behaviour policy which is not necessarily related to the policy to be learned, Q-learning is an example of an off-policy method.

A learner performing Q-learning, or any other type of reinforcement learning method, is only able to learn how a control agent should behave when faced with identical or similar situations to those previously experienced during the collecting of experience data. The control agent therefore generally acts without concern for rare events which may not have been encountered before, or not often, including failures which may result in highly dangerous or costly outcomes. Such considerations are particularly important for environments presenting potential risks to human safety.

### SUMMARY

According to a first aspect of the invention, there is provided a computer-implemented method. The method includes receiving data indicative of one or more experience tuples each comprising a first observation including a first location of an unmanned aerial vehicle, UAV, a first flight action performed by the UAV in dependence on the first observation, a reward associated with the performance of the first flight action, and a second observation including a second location of the UAV following the performance of the first action. For each of the one or more experience tuples, the method includes, at a computing system: processing the first observation, using a value estimator with current parameter values, to determine a first estimated return for the first flight action following the first observation; processing the second observation, using a target value estimator with an identical architecture to the value estimator, to determine a set of candidate estimated returns, each of the set of candidate estimated returns corresponding to a respective one of a set of candidate second flight actions following the second observation; determining a greatest of the determined candidate estimated returns; determining a terminal reward associated with a triggering of a failure condition corresponding to a failure of a physical component of the UAV following the UAV visiting the second location of the UAV; determining, using the determined terminal reward and the greatest candidate estimated return, a second estimated return for the first flight action following the first observation, accounting for an intervention by an adversarial stopping agent arranged to trigger the failure condition when predetermined stopping criteria are satisfied; and updating the current parameter values of the value estimator in dependence upon a difference between the first estimated return and the second estimated return. After being sequentially updated in accordance with each of the one or more experience tuples, the current parameter values of the value estimator are trained parameter values.

According to a second aspect of the invention, there is provided a computer-implemented method. The method includes receiving data indicative of one or more experience tuples each comprising a first observation characterizing a first state of an environment, a first action performed by the control agent in dependence on the first observation, a reward associated with the performance of the first action, and a second observation characterizing a second state of the environment following the performance of the first action. For each of the one or more experience tuples, the method includes, at a computer system: processing the first observation, using the value estimator with current parameter values, to determine a first estimated return for the first action following the first observation; processing the second observation, using a target value estimator having an identical architecture to the value estimator, to determine a set of candidate estimated returns, each of the set of candidate estimated returns corresponding to a respective one of a set of candidate second actions following the second observation; determining a greatest of the candidate estimated returns; determining a terminal reward associated with a triggering of a failure condition in the second state of the environment; determining, using the determined terminal reward and the greatest candidate estimated return, a second estimated return for the first action following the first observation, accounting for an intervention by an adversarial stopping agent arranged to trigger the failure condition when predetermined stopping criteria are satisfied; and updating the current parameter values of the value estimator in dependence upon a difference between the first estimated return and the second estimated return. After being sequentially updated in accordance with each of the one or more experience tuples, the current parameter values of the value estimator are trained parameter values.

According to a third aspect of the invention, there is provided a data processing system arranged to perform methods in accordance with the first and/or second aspect of the invention.

Introducing the adversarial stopping agent results in the learned policy accounting for possible failures within the system controlled by the control agent. In an example, the adversarial stopping agent is arranged to trigger a failure condition at a worst possible time, as determined by the terminal reward associated with triggering of the failure condition being lower than the expected return for a given state. In this case, a risk-averse policy is learned which is robust against faults leading to potentially catastrophic outcomes. A control system acting in accordance with a policy learned in this way may be suitable for environments in which safe operating standards must be ensured such as healthcare, factory automation, and supply chain management. Furthermore, a policy learned in accordance with the present disclosure will be robust against malicious attacks in cases where a control system is vulnerable to such attacks.

### BRIEF DESCRIPTION OF THE DRAWINGS

FIG. 1 is a schematic block diagram representing a reinforcement learning system according to examples;

FIG. 2 is a flow diagram representing a control agent interacting with an environment according to examples;

FIG. 3 is a flow diagram representing a control agent interacting with an environment in the presence of an adversarial stopping agent according to examples;

FIG. 4 is a flow diagram representing a method for training a value estimator for use in determining actions to be performed by a control agent interacting with an environment according to examples;

FIG. 5 shows schematically an unmanned aerial vehicle with a fault-tolerant control system according to examples;

FIG. 6 shows an example of possible flight paths for the unmanned aerial vehicle of FIG. 5; and

FIG. 7 shows schematically a traffic intersection with a fault-tolerant control system according to examples.

### DETAILED DESCRIPTION

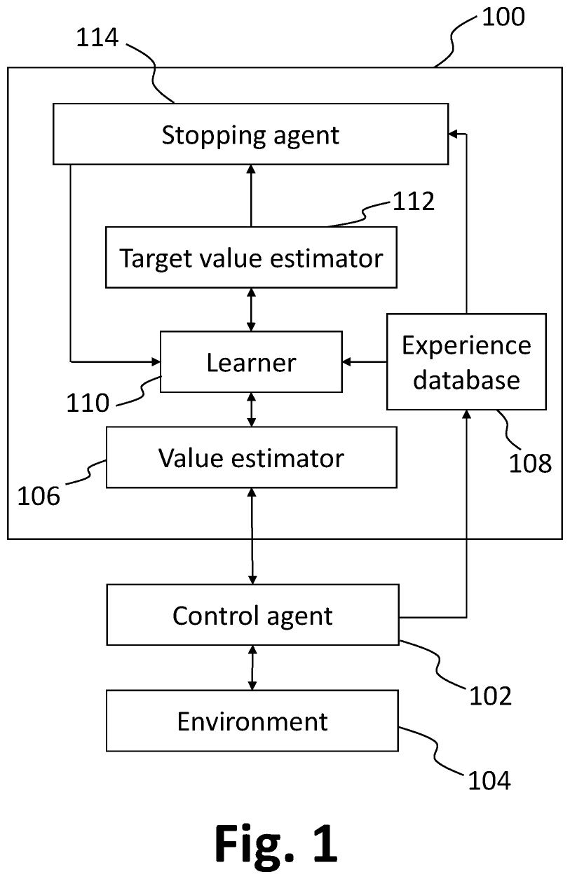

FIG. 1 shows an example of a reinforcement learning system 100 communicatively coupled with a control agent 102. The control agent 102 in this example is a software component arranged to interact with an environment 104. In this example, the environment 104 is a physical environment and the control agent 102 controls a physical entity in the environment 104 having one or more sensors (not shown) arranged to determine one or more characteristics of the environment 104, and one or more actuators (not shown) arranged to induce a change in state of the environment 104. In other examples, an environment is a virtual or simulated environment. Specific examples with be described hereinafter.

The reinforcement learning system 100 includes a value estimator 106, which is a component arranged to estimate an expected return for actions available to the control agent 102 in response to a given observation, for example as defined by Equation (2) above. Examples of suitable value estimators include: lookup tables storing estimates for each possible combination of observation and action (sometimes referred to as a Q table); estimators based on linear basis expansions, for example radial basis functions such as Gaussian radial basis functions; and deep neural networks (sometimes referred to as deep Q networks). The value estimator is implemented using processing circuitry and memory circuitry. In some examples, the value estimator is implemented using specialist hardware, for example a neural processing unit (NPU), a neural network accelerator, a digital signal processor (DSP) or an application-specific integrated processor (ASIC). In other examples, the value estimator may be implemented using general processors, for example a central processing unit (CPU) and/or a graphics processing unit (GPU).

The reinforcement learning system 100 further includes an experience database 108 configured to store experience tuples generated by the control agent 102, as will be described in more detail hereafter. A computer-implemented learner 110 is arranged to process experience tuples stored in the experience database 108 in accordance with methods described herein, to train the value estimator 106 to determine more accurate expected returns. In order to perform this training, the learner 110 has access to a target value estimator 112, which is functionally identical to the value estimator 106 and has an identical architecture to the value estimator 106 (for example, having the same table structure in the case of a lookup table, the same basis functions in the case of a basis function expansion, or the same network architecture in the case of a deep neural network), but which, at any time, may have different parameter values to the value estimator. In other examples, the value estimator 106 also plays the role of the target value estimator 112.

The reinforcement learning system 100 includes a stopping agent 114, which is arranged to process experience tuples from the experience database 108, and to determine, for a given experience tuple, whether or not to trigger a failure condition, depending whether predetermined stopping criteria are satisfied. As will be explained in more detail hereafter, during training of the value estimator 106, the learner 110 receives decisions from stopping agent 114 as to whether to trigger the failure condition. The stopping criteria applied by the stopping agent 114 are designed such that the stopping agent 114 acts to minimize the return of the control agent 102. In other words, the stopping agent 114 is configured to act as an adversary to the control agent 102, resulting in a contest between the two agents which can be modeled as a stochastic game. During training, the learner 110 trains the value estimator 106 such that the behavior of the control agent 102 tends towards equilibrium behavior corresponding to a so-called saddle point equilibrium of the stochastic game. As will be explained in more detail hereafter, the resulting policy is a fault-tolerant policy which is robust against failures leading to catastrophic events.

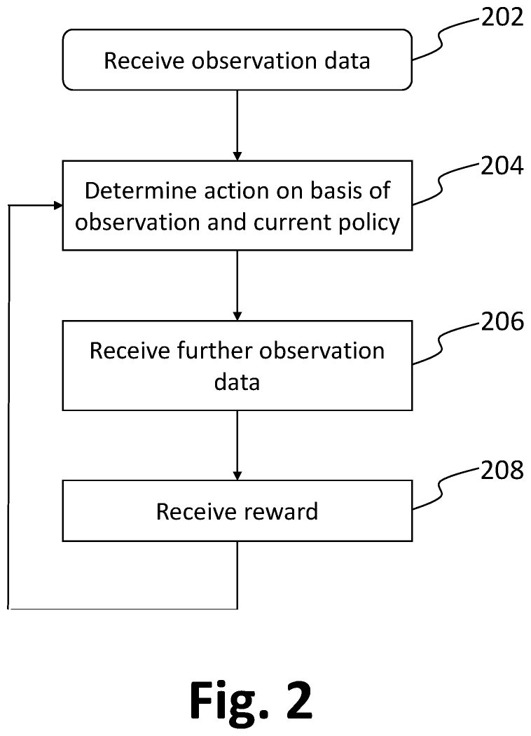

As shown in FIG. 2, the control agent 102 interacts with the environment 104 by receiving, at 202, observation data indicative of an observation characterizing a current state of the environment 104. In this example, the observation data received by the control agent 102 contains only a partial characterization of the corresponding state of the environment 104, and may furthermore be corrupted by sensor noise or other sources of inaccuracy. In other examples, such as in the case of certain virtual or simulated environments, observation data may include a complete characterization or description of the corresponding state of the environment. In examples, the partial or complete characterization of the environment is encoded as a low-dimensional feature vector.

Having received the observation data, the control agent 102 determines, at 204, an action to perform in dependence on the observation and a current policy. The control agent 102 has two main operational modes, namely a data gathering mode and an exploitation mode. In the present example, the nature of the policy depends on whether the control agent 102 is operating in the data gathering mode or in the exploitation mode. In the data gathering mode, the control agent 102 behaves in accordance with an exploration policy, whereas in the exploitation mode, the control agent 102 behaves in accordance with a policy learned using methods described herein, as will be explained in more detail hereafter. The control agent 102 performs the determined action, which in the present example involves sending a control signal to one or more of the actuators arranged to induce a change of state of the environment 104.

Having performed the determined action, the control agent 102 receives, at 206, further observation data indicative of an observation characterizing a next state of the environment 104 following the performance of the determined action. The control agent 102 also receives, at 208, a reward which is a numerical figure of merit that may be positive or negative (where in some examples a negative reward may be interpreted as a cost). In some examples, the reward is computed on the basis of the second state observation data. In some other examples, the reward is an intrinsic reward received from the environment 104, for example corresponding to a financial reward or other quantifiable resource.

The control agent 102 continues to interact with the environment 104 in accordance with 204-208. When the control agent 102 is operating in data gathering mode, the control agent 102 stores experience data indicative of experience tuples each containing a first observation, a performed action, a second observation subsequent to the performed action, and a reward, for subsequent processing by the learner 110 when training the value estimator 106.

At any point during the interaction between the control agent 102 and the environment 104, a failure may occur in the environment, at which point a failure condition may be triggered. For example, if the control agent 102 controls a physical entity having a plurality of physical components, one or more of these physical components could fail during the operation of the control agent 102. In response to such a failure being detected, a failure condition may be triggered.

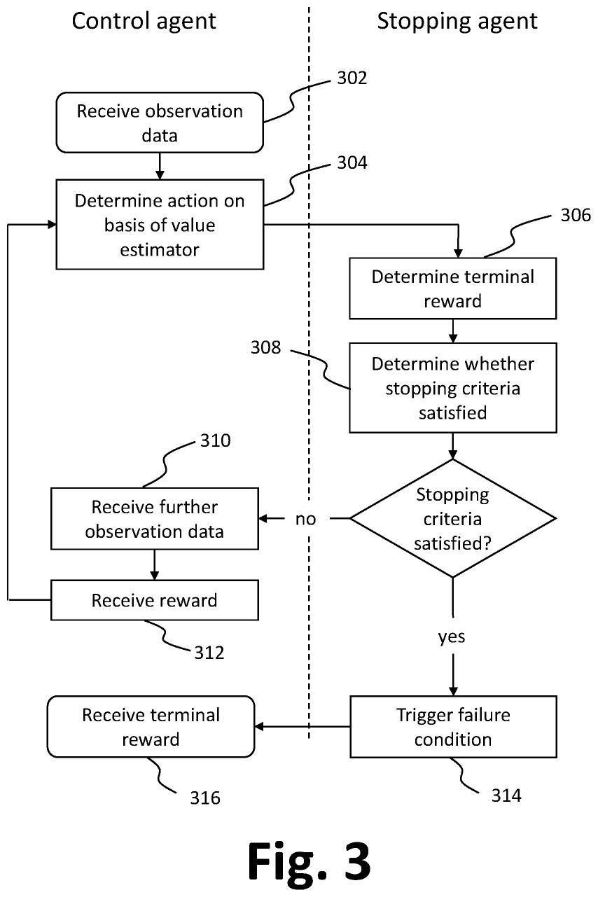

FIG. 3 again shows the control agent 102 interacting with environment 104, but this time in the presence of the adversarial stopping agent 114. The control agent 102 receives, at 302, observation data indicative of an observation characterizing a current state of the environment 104. Having received the observation data, the control agent 102 determines, at 304, an action to perform in dependence on the observation. In this case, the observation data is processed using the value estimator 106, and the determined action is that which is estimated by the value estimator 105 to have the highest expected return.

The stopping agent 114 determines, at 306, a terminal reward associated with a triggering of a failure condition in the current state of the environment. The terminal reward is a penalty value associated with the failure condition being triggered at that time. In some examples, a terminal reward can be determined exactly, for example where the terminal reward is an artificial predetermined value, chosen to be representative of a risk or an amount of loss or damage associated with a failure corresponding to the failure condition. In cases where such a failure could result in a truly catastrophic outcome, a terminal reward may be assigned a very high negative value. In some examples, the terminal reward corresponds to a loss of a quantifiable resource.

In some examples, the terminal reward cannot be determined exactly, and the terminal reward determined at 306 is an estimated terminal reward. As mentioned above, in some examples, the control agent 102 controls a physical entity having multiple physical components, one or more of which could fail at any time during operation of the control agent 102. The physical components could be, for example, power supplies, motors, sensors or actuators for a robot or other machine, for example an autonomous vehicle such as an autonomous car or an unmanned aerial vehicle (UAV). In these examples, a failure condition may correspond to a failure of any one of the physical components. As a result of such a failure, the control agent 102 may only be able to access a subset of the actions which would otherwise be available in response to a given observation. In this case, the terminal reward estimated by the stopping agent 112 for a given observation includes a modified estimated return for that observation, taking into account the reduced subset of actions available to the control agent 102. In examples, a further value estimator (not shown) for determining the modified estimated returns may be trained alongside the value estimator 106. The stopping agent 112 can use the further value estimator to estimate terminal rewards for a given observation. Alternatively, the functionality of the value estimator 106 can be extended to determine modified estimated returns (for example, using one or more additional network outputs in the case of the value estimator 106 being implemented using a deep neural network).

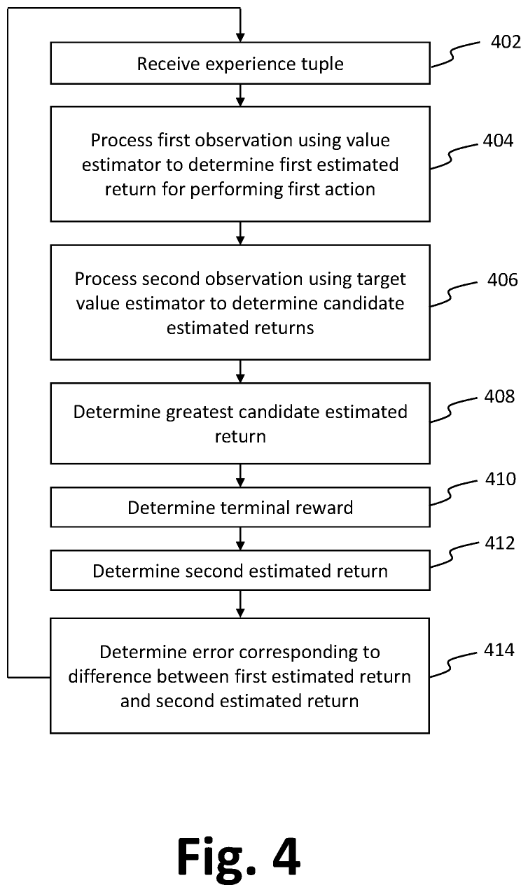

The stopping agent 114 determines, at 308, whether predetermined stopping criteria are satisfied. The nature of the stopping criteria depends on the configuration of the stopping agent 114, and as will be explained in more detail hereafter, during training of the value estimator 106, different stopping criteria applied by the stopping agent 114 will result in different behaviors of the control agent 102. In the present example, the stopping criteria include the terminal reward determined at 306 being lower than that the expected return for the action determined at 304, as estimated by the value estimator 106. This corresponds to the best strategy of the stopping agent 114 to minimise the actual return of the control agent 102. In other examples, different stopping criteria are applied by the stopping agent 114. For example, the stopping agent 114 can be configured to estimate a distribution over terminal rewards, in which case the stopping criteria can include a given quantile of the terminal reward distribution being lower than the expected return estimated by the value estimator 106. During training of the value estimator 106 (described below with reference to FIG. 4), different stopping criteria implemented by the stopping agent 114 will result in different behaviors of the control agent 102.

When the stopping agent 114 determines that the stopping criteria are not satisfied, the control agent 102 can continue to interact with the environment 102, and receives, at 310, further observation data indicative of an observation characterizing a next state of the environment 102 following the performance of the action determined at 304. The control agent 102 also receives a reward at 312. Provided that the stopping agent 114 does not determine that the stopping criteria are satisfied, the control agent 102 can continue to interact with the environment 102 in accordance with 304-312.

When the stopping agent 114 determines that the stopping criteria are satisfied, the stopping agent 114 triggers the associated failure condition. As a result of triggering of the failure condition, a terminal reward is determined. In some examples, the terminal reward is equal to the terminal reward determined by the stopping agent 114 at 306. In other examples, the actual terminal reward is higher or lower than the terminal reward determined at 306.

The interaction between the control agent 102 and the stopping agent 114 can be modeled as a stochastic game. It has been shown by the inventor that the stochastic game has a saddle point equilibrium, wherein the control agent 102 and the stopping agent 114 each implements a respective fixed strategy, and neither the control agent 102 nor the stopping agent 114 can improve its expected outcome by modifying its respective fixed strategy. An objective of the present disclosure is to provide a method of training the value estimator 106 such that the control agent 102 implements a strategy approximating that of the saddle point equilibrium. Because this strategy is a best possible strategy against the adversarial stopping agent 114, the strategy is robust against faults occurring at the worst possible time, for example faults which lead to catastrophic events. The strategy is highly risk-averse and is thus highly suitable for environments in which safe operating standards must be ensured.

FIG. 4 shows a method performed by the data processing system 100 for training the value estimator 106 in such a way that actions determined on the basis of the trained value estimator 106 correspond to the risk-averse strategy described above. Prior to the method of FIG. 4 being performed, the control agent 102 operates in a data gathering mode to generate experience data indicative of experience tuples as described above with reference to FIG. 2 and stores the generated experience database in the experience database 108. Parameter values of the value estimator 106 and the target value estimator 112 are initialized, for example to random values. In the present example, the parameter values of the value estimator 106 and the target value estimator 112 are each initialized to the same set of random values.

The learner 110 receives, at 402, an experience tuple from the experience database 108. The experience tuple includes a first observation sₜ characterizing a first state of the environment 104, a first action aₜ performed by the control agent 102 in response to the first observation, a second observation sₜ₊₁ characterizing a second state of the environment 104 following the performance of the first action, and a reward rₜ received by the control agent 102 following the performance of the first action. In this example, the experience tuple is selected randomly from the experience database 108. Selecting experience tuples randomly, as opposed to selecting experience tuples in the order in which they were generated, is known as experience replay and is known to reduce bias in Q-learning and related reinforcement learning algorithms by eliminating the effect of correlations between neighboring experience tuples.

The learner 110 processes, at 404, the first observation of the received experience tuple using the value estimator 106, to determine a first estimated return Q (sₜ, aₜ) for performing the first action aₜ in response to the first observation sₜ. The first estimated return is based purely on the first observation and the first action, and does not take into account the reward rₜ that was actually received following the performance of the first action.

The learner 110 processes, at 406, the second observation of the received experience tuple using the target value estimator 112, to determine a candidate estimated return \hat{Q}(sₜ₊₁, aₜ₊₁) for performing each of a set of candidate second actions aₜ₊₁ in response to the second observation sₜ₊₁ (note that the hatted symbol \hat{Q} indicates a return estimated using the target value estimator 112, as opposed to the value estimator 106). The learner 110 determines, at 408, a greatest of the determined candidate estimate returns.

The stopping agent 114 estimates determines, at 410, a terminal reward G (sₜ₊₁) associated with a triggering of a failure condition in the second state of the environment 104.

The learner 110 determines, at 412, a second estimated return for performing the first action aₜ in response to the first observation sₜ, using the greatest candidate estimated return determined at 408 and the terminal reward determined at 410. In the present example, the second estimated return is given by

$${r}_{t} + γ min ( {max}_{{a}_{t + 1}} \hat{Q} ( {s}_{t + 1} , {a}_{t + 1} ) , G ( {s}_{t + 1} ) ) ,$$

which is based on the assumption that the stopping agent 114 will trigger the failure condition if the terminal reward estimated at 410 is lower than the highest candidate estimated return determined at 408. In other words, the second estimated return is based on the assumption that the stopping agent 114 will trigger the failure condition if doing so will reduce the expected discounted future reward of the control agent 102. This corresponds to an adversarial strategy in which the stopping agent 114 always tries to trigger the failure condition at the worst possible time, from the perspective of the control agent 102.

The learner 110 updates, at 414, parameter values of the value estimator 106, in dependence upon a difference between the first estimated return determined at 404 and the second estimated return determined at 412. In this example, the difference is given by Equation (3):

$${r}_{t} + γ min ( {max}_{{a}_{t + 1}} \hat{Q} ( {s}_{t + 1} , {a}_{t + 1} ) , G ( {s}_{t + 1} ) ) - Q ( {s}_{t} , {a}_{t} ) . \qquad ( 3 )$$

The update is chosen such that if the difference were recalculated using the updated parameter values, the recalculated difference would have a smaller absolute value (or squared value). The form of the update depends on the implementation of the value estimator 106. For example, when the value estimator 106 is implemented using a lookup table, the value of the entry for Q (sₜ, aₜ) is updated using the update rule of Equation (4):

$$Q ( {s}_{t} , {a}_{t} ) ← Q ( {s}_{t} , {a}_{t} ) + α [ {r}_{t} + γ min ( {max}_{{a}_{t + 1}} \hat{Q} ( {s}_{t + 1} , {a}_{t + 1} ) , G ( {s}_{t + 1} ) ) - Q ( {s}_{t} , {a}_{t} ) ] . \qquad ( 4 )$$

In another example, the value estimator 106 is implemented using a linear basis function expansion of the form Q(s, a)=Σⱼc(j)ϕⱼ(s, a), where c(j) for j=1, . . . N are coefficients for a set of basis functions ϕⱼ(s, a), which may be any form of suitable basis function, for example radial basis functions such as Gaussian radial basis functions. In this case, each of the coefficients c(j) is updated using the update rule of Equation (5):

$$c ( j ) ← c ( j ) + {αϕ}_{j} ( {s}_{t} , {a}_{t} ) [ {r}_{t} + γmin ( {max}_{{a}_{t + 1}} ( {\sum }_{j} \hat{c} ( j ) {ϕ}_{j} ( {s}_{t + 1} , {a}_{t + 1} ) , G ( {s}_{t + 1} ) ) - {\sum }_{j} c ( j ) {ϕ}_{j} ( {s}_{t} , {a}_{t} ) ] , \qquad ( 5 )$$

where ĉ(j) denotes values of the coefficients for the target value estimator 112.

In a further example, the value estimator 106 is implemented using a deep neural network with a parameter values θ including connection weights and biases within the network. In this case, the parameter values θ are updated using the update rule of Equation (6):

$$θ ← θ + α [ {r}_{t} + γmin ( {max}_{{a}_{t + 1}} \hat{Q} ( {s}_{t + 1} , {a}_{t + 1} ) , G ( {s}_{t + 1} ) ) - Q ( {s}_{t} , {a}_{t} ) ] {∇}_{θ} Q ( {s}_{t} , {a}_{t} ) , \qquad ( 6 )$$

where the gradient ∇_{θ}Q(sₜ, aₜ) of the deep neural network is computed using backpropagation, as will be understood by those skilled in the art.

The method of FIG. 4 is performed sequentially for multiple experience tuples, resulting in iterative updating of the parameter values of the value estimator 106. In some examples, the same experience tuple may be processed multiple times. In some examples, the learner 110 updates parameter values of the target value estimator 112 to match the parameter values of the value estimator 106 after a predetermined number of iterations. In other examples the parameter values of the target value estimator 112 are identical to those of the value estimator 106 (in which case the value estimator 106 can also perform the function of the target value estimator 112).

Once the value estimator 106 has been trained using this method (for example, once predetermined convergence conditions are determined to be satisfied or once a predetermined number of training iterations have taken place), the trained value estimator 106 is ready to be used by the control agent 102.

The control agent 102 can operate in an exploitation mode by implementing a greedy policy with respect to the trained value estimator 106. In this mode, for each observation of the environment 104, the control agent 12 always selects the available action with the highest return Q(s, a) as estimated using the trained value estimator 106. The resulting policy approximates the best strategy for the control agent 102 in the stochastic game represented by FIG. 3, and is accordingly a risk-averse, fault tolerant policy as explained above.

Alternatively, the control agent 102 can operate in a data gathering mode, for example by implementing an epsilon-greedy policy with respect to the value estimator 106, in which for each observation of the environment 104, the control agent 102 selects a random action with probability ∈, and a greedy action with probability 1−∈, where 0<∈<1.

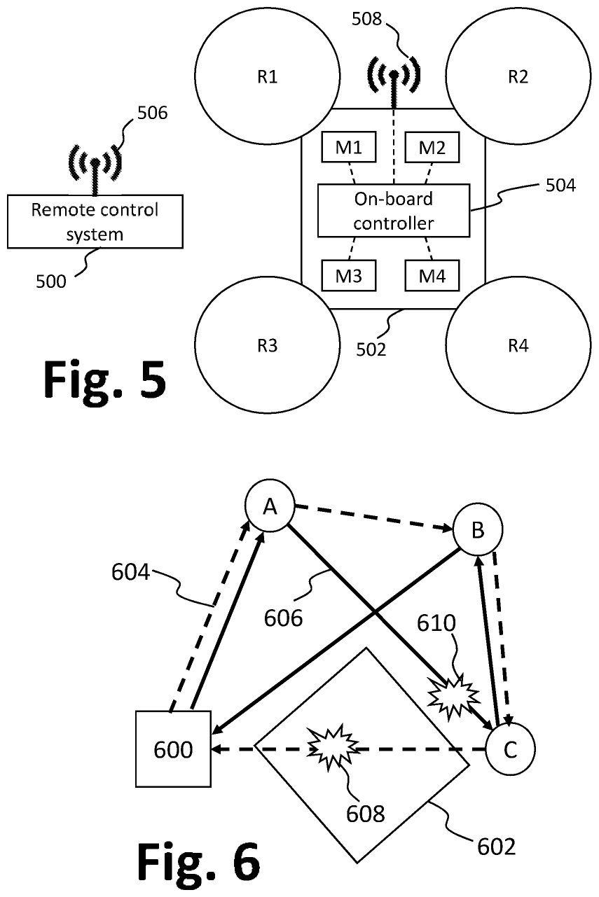

FIG. 5 shows an example of a remote control system 500 for a UAV 502. In this example, the UAV 502 is used to deliver parcels from a depot 600 (shown in FIG. 6). The control system 500 determines actions for the UAV 502 as will be described in more detail hereafter, and transmits the determined actions to an on-board controller 504 of the UAV 502 via transceivers 506 and 508. The UAV 502 has four rotors R1-R4, which are examples of actuators, and four motors M1-M4 for driving the rotors R1-R4. In the present example, the UAV 502 can only fly when all four motors and all four rotors are operational. Failure of any of these components, or the on-board controller 504, causes the UAV 502 to crash land.

FIG. 6 shows examples of flight paths of the UAV 502 performing a task of delivering parcels to three drop-off points A, B and C. At the beginning of the task, and after each delivery, the remote control system 500 determines a flight action indicating a next location for the UAV 502, and transmits data to the UAV 502 indicative of the determined next location. The on-board controller 504 then provides control signals to the motors M1-M4 driving the rotors R1-R4, causing the UAV 502 to fly to the determined next location. A positive reward is determined each time the UAV 502 reaches a drop-off point, and aim of the remote control system 500 is to determine flight paths yielding the highest return over a given period of time (for example, an hour or a day). If the UAV 502 crash lands, a negative terminal reward is determined which depends on the location at which the UAV 502 crash lands (the terminal reward may vary, for example, depending on the likelihood of the UAV 502 being recovered, the expected time taken for the UAV 502 to be recovered, and the density of pedestrians and/or vehicles, accounting for the potential danger caused by the crashing UAV 502). In the present example, the terminal reward is determined in dependence on location data indicating the location of the UAV 502 with respect to a predetermined map when the failure condition is triggered. The square 602 in FIG. 6 is a pedestrianized square with a particularly high density of pedestrians.

The dashed arrows in FIG. 6 show a flight path 604 for the UAV 502 determined using a conventional reinforcement learning method. It is observed that the remote control system 500 selects the shortest possible flight path, namely 600-A-B-C-600. The solid arrows show a flight path 606 determined by the remote control system 500 in accordance with the methods described herein. It is observed that the flight path 606 is slightly longer than the flight path 604. However, the flight path 606 represents a risk-averse policy, as demonstrated by the points 608 and 610, which represent the worst possible locations for a crash landing of the UAV 502 on the flight paths 604 and 606 respectively. A crash at the point 608 on the flight path 604 corresponds to a much more negative terminal reward than a crash at the point 610 on the flight path 606, due to the high pedestrian density in the pedestrianized square 602. By training a value estimator in the remote control system 500 using the method described with reference to FIG. 4, the remote control system 500 implements a fault-tolerant policy which is robust against failures causing catastrophic events. In this example, due to the adversarial nature of the stopping agent, the terminal reward determined at 410 is the most negative terminal reward possible for the failure condition being triggered following the second observation (but before the next observation).

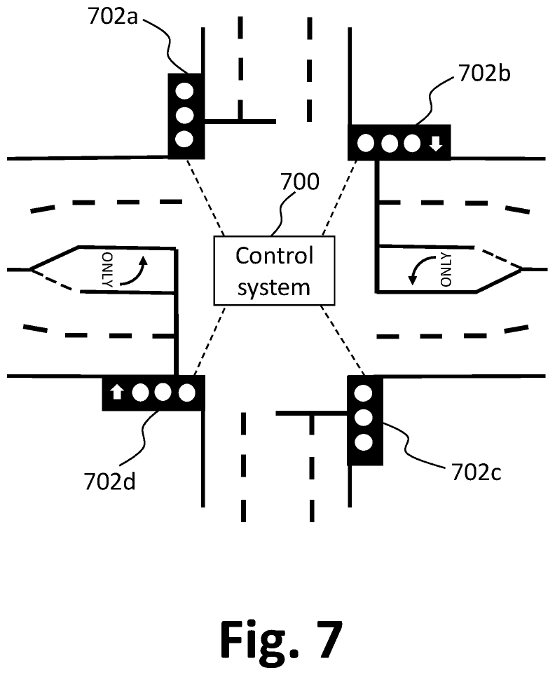

FIG. 7 shows an example of a traffic control system 700 arranged to schedule traffic lights 702a-d at a four-way traffic junction. At each of a sequence of time steps, cameras (not shown) observe traffic on each incoming street of the junction, and transmit data to the control system 700 indicative of delays experienced by vehicles on the incoming roads. At any given time, a state of the environment corresponds to a permutation of states of the traffic lights 702 and information about delays on each of the incoming streets. At each time step, the control system 700 selects an action inducing a new permutation of states of the traffic lights 702, and receives a reward based on the observed delays of the vehicles.

In the example of FIG. 7, a failure of any of the traffic lights 702 could lead to a catastrophic outcome, either in terms of excessive congestion or a collision between vehicles. In this example, a value estimator in the control system 700 is trained using the method described above with reference to FIG. 4, causing the control system 700 to implement a fault-tolerant policy which is robust against failures causing such catastrophic outcomes. The methods described herein could be used for more complex junctions or systems of junctions, either using a single centralized control system or using a set of control systems which in some examples can exchange data with one other (corresponding to a multi-agent reinforcement learning setting).

The above embodiments are to be understood as illustrative examples of the invention. Other applications of the invention are envisaged. For example, the example described with reference to FIG. 6 could be adapted for an autonomous vehicle such as an autonomous car. In a further example, methods described herein could be used to train an automatic driving system for an autonomous vehicle such as an autonomous car. A further example is a control system for a surgery-performing robot. In this example, it is desirable for the robot to perform surgery quickly, but it is of paramount importance that dangerous actions are avoided which have a risk of causing catastrophic outcomes (such as the death or serious injury of a patient). The methods described herein are well-suited to training a control system in this setting. In other examples, a control agent may be used for determining actions in a virtual setting, such as in trading stocks or other financial instruments. In this case, the methods described herein can be used to implement a safe strategy which, as far as is possible, avoids the possibility of catastrophic losses.

In an example in which different types of failure conditions are possible (for example, corresponding to a failure of a motor or a failure of an actuator), a stopping agent could be arranged to trigger a failure condition corresponding to any one of these types of failure when a corresponding stopping condition is satisfied. Each failure condition may result in a different terminal reward.

In examples, a semiconductor device is provided with logic gates arranged to perform the processing functions of one or more components of the reinforcement learning system 100. In other examples, a computer program product is provided comprising computer-readable instructions which, when executed by a computer system, cause the computer system to perform the methods described above. In one example, the computer program product is a non-transient computer-readable storage medium.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A computer-implemented method comprising:
receiving data indicative of one or more experience tuples each comprising a first observation including a first location of an unmanned aerial vehicle, UAV, a first flight action performed by the UAV in dependence on the first observation, a reward associated with the performance of the first flight action, and a second observation including a second location of the UAV following the performance of the first action;
for each of the one or more experience tuples, at a computing system:
processing the first observation, using a value estimator with current parameter values, to determine a first estimated return for the first flight action following the first observation;
processing the second observation, using a target value estimator with an identical architecture to the value estimator, to determine a set of candidate estimated returns, each of the set of candidate estimated returns corresponding to a respective one of a set of candidate second flight actions following the second observation;
determining a greatest of the determined candidate estimated returns;
determining a terminal reward associated with a triggering of a failure condition corresponding to a failure of a physical component of the UAV following the UAV visiting the second location of the UAV;
determining, using the determined terminal reward and the greatest candidate estimated return, a second estimated return for the first flight action following the first observation, accounting for an intervention by an adversarial stopping agent arranged to trigger the failure condition when predetermined stopping criteria are satisfied; and
updating the current parameter values of the value estimator in dependence upon a difference between the first estimated return and the second estimated return,
wherein, after being sequentially updated in accordance with each of the one or more experience tuples, the current parameter values of the value estimator are trained parameter values.

2. The method of claim 1, wherein the terminal reward is determined in dependence on location data indicating the location of the UAV with respect to a predetermined map when the failure condition is triggered.

3. A computer-implemented method comprising:
receiving data indicative of one or more experience tuples each comprising a first observation characterizing a first state of an environment, a first action performed by a control agent in dependence on the first observation, a reward associated with the performance of the first action, and a second observation characterizing a second state of the environment following the performance of the first action;
for each of the one or more experience tuples:
processing the first observation, using a value estimator with current parameter values, to determine a first estimated return for the first action following the first observation;
processing the second observation, using a target value estimator with an identical architecture to the value estimator, to determine a set of candidate estimated returns, each of the set of candidate estimated returns corresponding to a respective one of a set of candidate second actions following the second observation;
determining a greatest of the set of candidate estimated returns;
determining a terminal reward associated with a triggering of a failure condition in the second state of the environment;
determining, using the determined terminal reward and the greatest candidate estimated return, a second estimated return for the first action following the first observation, accounting for an intervention by an adversarial stopping agent arranged to trigger the failure condition when predetermined stopping criteria are satisfied; and
updating the current parameter values of the value estimator in dependence upon a difference between the first estimated return and the second estimated return,
wherein, after being sequentially updated in accordance with each of the one or more experience tuples, the current parameter values of the value estimator are trained parameter values.

4. The method of claim 3, wherein the predetermined criteria for triggering the failure condition include the determined terminal reward being lower than the second estimated return for the first observation and the first action.

5. The method of claim 3, wherein
the environment is a physical environment; and
for each of the one or more experience tuples, the first and second observations are made using one or more sensors.

6. The method of claim 5, wherein for each of the one or more experience tuples, the first action is performed using one or more actuators.

7. The method of claim 3, wherein:
the control agent is arranged to control an autonomous vehicle;
the second observation characterizing a second state of the environment is indicative of a current location of the autonomous vehicle;
the failure condition corresponds to a mechanical failure of a physical component of the autonomous vehicle; and
the terminal reward associated with the triggering of the failure condition in the second state of the environment depends on the indicated current location of the autonomous vehicle.

8. The method of claim 7, wherein the autonomous vehicle is a UAV.

9. The method of claim 7, wherein the control agent is arranged to determine a route for the autonomous vehicle.

10. The method of claim 3, wherein:
the environment is a physical environment;
the control agent is arranged to control a physical entity in the physical environment, the physical entity having a plurality of physical components;
the failure condition corresponds to a failure one of the physical components, resulting in a reduced set of actions being available to the control agent; and
the terminal reward associated the triggering of the failure condition in the second state comprises an estimated return for the second observation taking into account the reduced set of actions available to the control agent.

11. The method of claim 10, wherein said physical components are power supplies for a machine.

12. The method of claim 10, wherein said physical components are sensors.

13. The method of claim 10, wherein said physical components are actuators.

14. The method of claim 3, wherein the value estimator and the target value estimator are identical.

15. The method of claim 3, comprising updating parameter values of the target value estimator to match the current parameter values of the value estimator after a predetermined number of updates of the current parameter values of the value estimator.

16. The method of claim 3, wherein:
the value estimator comprises a deep neural network with a given architecture; and
the target value estimator comprises a deep neural network with the same architecture as the value estimator.

17. the method of claim 3, wherein:
the value estimator comprises a linear combination of predetermined basis functions; and
the target value estimator comprises a linear combination of the same predetermined basis functions as the value estimator.

18. The method of claim 3, comprising:
receiving data indicative of a third observation characterizing a third state of the environment;
processing the third observation, using the value estimator with the trained parameter values, to determine a candidate estimated return for the third observation and each of a set of candidate third actions; and
determining a best action as the candidate third action determined to have the greatest candidate estimated return.

19. The method of claim 18, comprising generating further data indicative of a further experience tuple for further training of the value estimator, wherein generating the further experience tuple comprises:
selecting a third action to be performed by the control agent in dependence on the third observation; and
receiving data indicative of a reward associated with the performance of the third action and a fourth observation characterizing a fourth state of the environment following the performance of the third action,
wherein selecting the third action comprises selecting randomly from the set of candidate third actions with a predetermined probability between zero and one, and otherwise selecting the determined best action.

20. A data processing system arranged to:
store data indicative of one or more experience tuples each comprising a first observation characterizing a first state of an environment, a first action performed by the control agent in dependence on the first observation, a reward associated with the performance of the first action, and a second observation characterizing a second state of the environment following the performance of the first action;
for each of the one or more experience tuples:
process the first observation, using a value estimator with current parameter values, to determine a first estimated return for the first action following the first observation;
process the second observation, using a target value estimator with an identical architecture to the value estimator, to determine a set of candidate estimated returns, each of the set of candidate estimated returns corresponding to a respective one of a set of candidate second actions following the second observation;
determine a greatest of the set of candidate estimated returns;
determine a terminal reward associated with a triggering of a failure condition in the second state of the environment;
determine, using the determined terminal reward and the greatest candidate estimated return, a second estimated return for the first action following the first observation, accounting for an intervention by an adversarial stopping agent arranged to trigger the failure condition when predetermined stopping criteria are satisfied; and
update the current parameter values of the value estimator in dependence upon a difference between the first estimated return and the second estimated return,
wherein, after being sequentially updated in accordance with each of the one or more experience tuples, the current parameter values of the value estimator are trained parameter values.
